(19) United States
(12) Patent Application Publication
(10) Pub. No.: US 2013/0328778 A1
(43) Pub. Date: Dec. 12, 2013

(54) METHOD OF SIMULATING THE TOUCH SCREEN OPERATION BY MEANS OF A MOUSE

(71) Applicants: Kuan-Ting CHEN, New Taipei City (TW); Shih-Ming Chang, New Taipei City (TW); Li-Chieh Wang, New Taipei City (TW)

(72) Inventors: Kuan-Ting CHEN, New Taipei City (TW); Shih-Ming Chang, New Taipei City (TW); Li-Chieh Wang, New Taipei City (TW)

(21) Appl. No.: 13/567,859

(22) Filed: Aug. 6, 2012

(30) Foreign Application Priority Data
Jun. 6, 2012 (TW) 101120216

(51) Int. Cl. G06F 3/033

(52) U.S. Cl. 345/163

(57) ABSTRACT

A method of simulating the touch screen operation by means of a mouse is provided and particularly makes the mouse work in a computer operating system with a screen touch function. The mouse comprises at least one simulation touch trigger button and one touch signal converter unit. Press the simulation touch trigger button, and the mouse will work in the touch mode. The touch signal converter unit intercepts a pressed button signal of the mouse and converts it into a screen touch signal for executing single-finger or multi-finger slide and touch functions. The mouse is further provided with a fixed-point button, and when the fixed-point button is pressed, where the mouse is corresponding to the screen, a finger press is simulated. The pressed position is fixed and does not move, and another button of the mouse is pressed to operate for executing the screen zoom-in, zoom-out, and rotation.

### BACKGROUND OF THE INVENTION

1. Field of the Invention

The present disclosure relates to a method of simulating the touch screen operation by means of a mouse.

2. Description of the Related Art

The touch screen is a screen functioning for screen display and pointing operation. A user just taps on a random location of the screen surface by a finger, a stylus, or another tool to make the touch screen sense and acknowledge the coordinates of the location taped by the user for inputting them to the computer's operating system.

Today, based on the induction principle, the touch screen can be divided into resistive, capacitive, ultrasonic, optical ones, which are different in that different media, such as the difference of the values of resistance, capacitance, ultrasonic or light) are used to input the coordinates of the location tapped by the user. Regarding the overall structure of the computer system, the touch screen is a display interface touch screen and can be defined to an input device.

With the mature touch screen technology and the Windows 7 operating system into which the multi-touch capability is embedded, the gesture message WM_GESTURE and the like, new-generation computer system and software developers are prompted to widely develop relative application software by referring to the multi-touch technology; the traditional display screen provided with only the displaying function can not certainly work with the single-finger touch or multi-finger touch feature in the computer's operating system, such as the screen pan function, two-finger gesture and the like to operate the screen, making the user to be forced to upgrade to the aforementioned touch screen or abandon the use of the touch function directly.

To this end, to use the high popular mouse to simulate the aforementioned touch feature of single finger or multi-finger slide or screen zoom, shrink or rotation is the goal to achieve in the this invention. Consequently, because of the technical defects of described above, the applicant keeps on carving unflaggingly through wholehearted experience and research to develop the present invention, which can effectively improve the defects described above.

### SUMMARY OF THE INVENTION

This invention is to provide a method of simulating the touch screen operation by means of a mouse in a computer's operating system provided with a screen touch function.

This invention is further to provide a single-finger or multi-finger slide touch function by means of the mouse.

This invention is next to provide a screen zoom, shrink or rotation touch function by means of the mouse.

For this reason, in order to achieve the technical means mentioned above, the method comprises a manner in which the mouse works in the computer's operating system provided with the single-finger and multi-finger touch functions. The mouse comprises at least one simulation touch trigger button and one touch signal converter unit. The method comprises:

Step 1 (S1) of detecting whether or not the simulation touch trigger button is pressed; if yes, going to Step 2 (S2); if not, keeping the mouse's basic function;

Step 2 (S2) of making the mouse work to simulate the screen touch mode; and

Step 3 (S3) of detecting whether or not the state of simulation touch trigger button is changed (to re-pressing or re-releasing); if yes, returning to the mouse's basic function; if not, keeping the mouse's touch mode.

At the same time, when the mouse works to simulate the screen touch mode, the touch signal converter unit is activated to separately intercept the signal of pressing of the button (touch buttons) of mouse or the mouse's operation signal and convert it to the feature of touch on the screen.

Based on the foregoing main features, the technical means of this method may comprise: making the mouse continue working in the touch simulation mode when the user presses one time of simulation touch button, and making the mouse exit from the touch mode and restore the mouse's basic function when the user presses again one time of simulation touch trigger button.

Based on the foregoing main features, the technical means of this method may comprise: entering the touch mode when the user presses the simulation touch trigger button and continuing working in the touch mode when the simulation touch trigger button is continuously pressed. When both the simulation touch trigger button and the touch button that were previously pressed are released, the mouse's basic function recovers.

Based on the foregoing main features, in the touch mode, when the mouse's single finger or multiple buttons (left button, right button, or middle button) are pressed at the same time, they are converted to touch points where the fingers are on the screen. Likewise, when the single or multiple buttons that were previously pressed is continuously pressed and the mouse is moved, they are converted to touch gestures in the screen were the single or multiple fingers translates and slides.

Based on the foregoing main features, the mouse working in the touch mode further comprises a fixing-point button. With the fixing-point button, the mouse may simulate the screen zoom, shrink or rotation on the touch screen.

When the fixing-point button is pressed, a position where the mouse is corresponding to the screen is converted to a fixed-point position. The fixed-point position cannot move with the mouse. Then, a position formed when another button is pressed is converted to a movable position. Thus, the operating system, based on the two positions closed to each other or distant from each other, may bring a zoom-in or zoom-out effect, or based on the movement position relative to the angular displacement variation of the fixed position, may control the rotation angle of the screen.

Further, when the mouse's basic function is executed and the fixed-point button is pressed, the touch mode may enter and the fixed-point touch mode can be executed.

Based on the foregoing main features, the converted touch point or fixed position or movable position of the mouse that is correspondingly in the screen in the touch mode may work and be shown as a real image cursor or a non-real image cursor.

### BRIEF DESCRIPTION OF THE DRAWINGS

FIG. 1 is a flow chart of a method of simulating the touch screen operation by means of a mouse in a first embodiment of this invention;

FIG. 2 is a 3D schematic view illustrating the mouse simulating the touch screen operation according to this invention;

FIG. 3 is a flow chart of a method of simulating the touch screen operation by means of the mouse in a second embodiment of this invention;

FIG. 4 is a 3D schematic view illustrating the mouse simulating the touch screen operation in a fixed-point touch mode according to this invention;

FIG. 5 is a flow chart of a method of simulating the touch screen operation by means of the mouse in a third embodiment of this invention;

FIG. 6 is a schematic view illustrating the method of simulating the touch screen operation by means of the mouse according to this invention that slides with a single-finger or multi-finger touch function;

FIG. 7 is a schematic view illustrating the method of simulating the touch screen operation by means of the mouse according to this invention, indicating that the fixed touch point and the movable touch point that are closed to each other or distant from each other; and

FIG. 8 is a schematic view illustrating the method of simulating the touch screen operation by means of the mouse according to this invention, indicating that the movable touch point revolves around the fixed touch point as the center of circle.

### DETAILED DESCRIPTION OF THE PREFERRED EMBODIMENTS

For technical features and effects in terms of the present disclosure completely understood and recognized, the preferred embodiments and detailed drawings are described hereinafter.

In this invention, the computer's operating system is a program that supervises the computer hardware and the computer software. The program also manages and allocates the storage, determines the priority of resource supply and demand, controls connected I/O devices and network and manages file systems and the like as general services and provides a man-machine interface making users interact with the system. In this invention, the operating system can be the Microsoft WINDOWS operating system, Mac OS, or Android OS, and this invention is not limited to the statement herein.

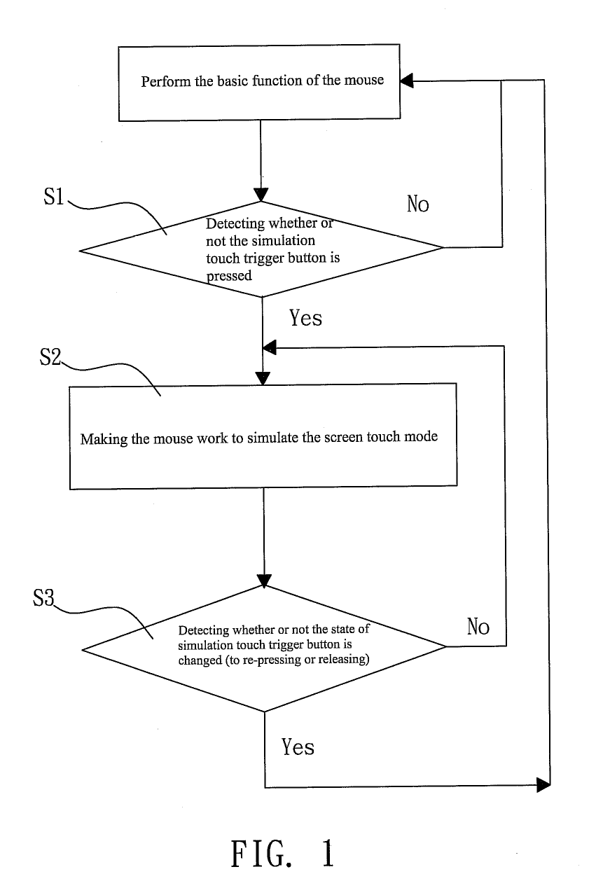

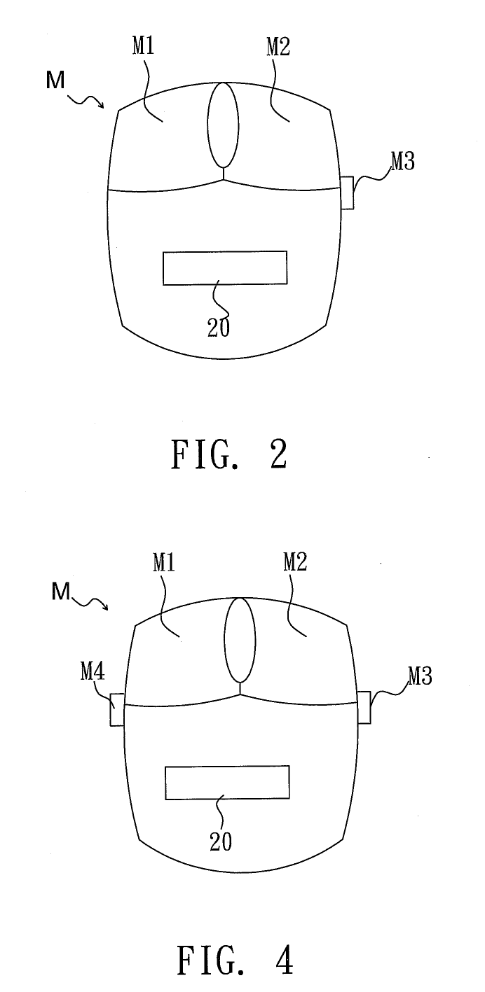

Refer to FIG. 1 and FIG. 2. FIG. 1 is a flow chart of a method of simulating the touch screen operation by means of a mouse in a first embodiment of this invention; FIG. 2 is a 3D schematic view illustrating the mouse simulating the touch screen operation according to this invention.

As shown in the figures, the mouse according to this invention works in a computer operating system supporting single-finger and multi-finger touch functions. The mouse M comprises at least one LED, one optical engine, one lens component, and one control element (not shown). The elements are used to detect the displacement of mouse M and control the cursor movement in the computer operating system (not described in detail here because of the mouse's basic functions). The mouse M further comprises a left button M1 and a right button M2. Especially, in this invention, the mouse M further comprises a simulation touch trigger button M3 and a touch signal converter unit 20, as shown in FIG. 2. When the simulation touch trigger button M3 is pressed, the touch signal converter unit 20 intercepts the signals of a single or multiple buttons of the mouse and converts them into touch signals to input to the computer operating system, thereby simulating single-finger or multi-finger touch gestures. For more details, the mouse according to this invention works in the following three steps described below.

In Step 1 (S1), detect whether or not the simulation touch trigger button M3 is pressed; if yes, go to Step 2 (S2); if not, keep the basic function of the mouse M.

In Step 2 (S2), the mouse M starts to work to simulate the screen touch mode. At the same time, the touch signal converter unit 20 is activated to separately intercept the signal of pressing of the button of mouse M or the mouse's operation signal and convert it to the function of touch on the screen, such as the function of single finger or multi-finger slide or screen zoom, shrink or rotation.

In Step 3 (S3), detect whether or not the state of simulation touch trigger button M3 is changed (to the re-pressing or re-releasing); if yes, return to the basic function of the mouse M; if not, keep the mouse's touch mode.

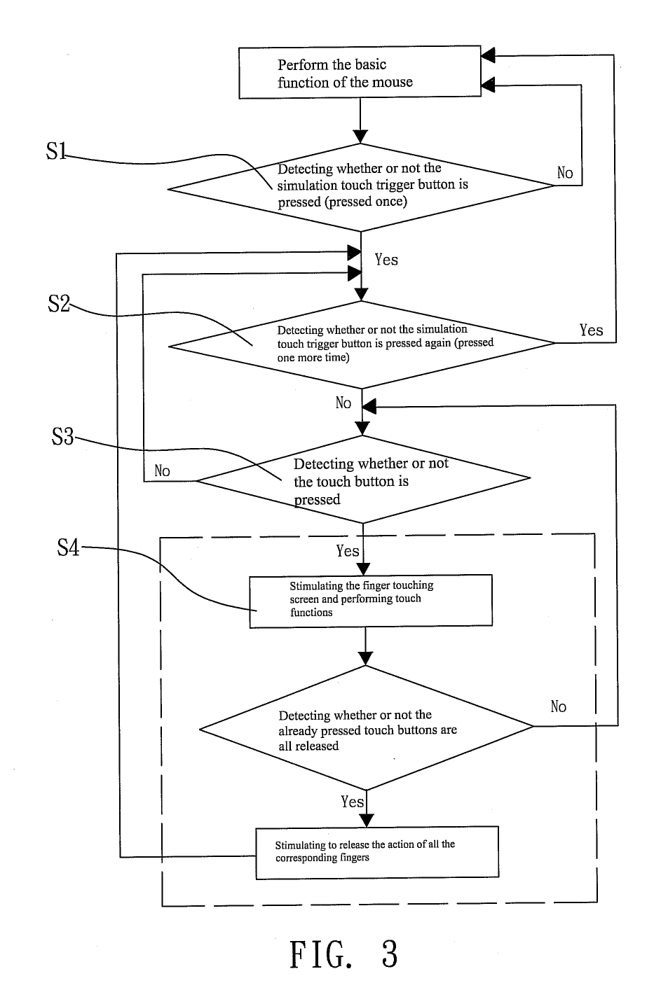

Refer to FIG. 3 and FIG. 4. FIG. 3 is a flow chart of the method of simulating the touch screen operation by means of the mouse in a second embodiment of this invention. FIG. 4 is a 3D schematic view illustrating the mouse simulating the touch screen operation in a fixed-point touch mode according to this invention. The method carrying out this invention comprises:

Step 1 (S1) of detecting whether or not the simulation touch trigger button M3 of the mouse M is pressed (one time); if yes, going to Step 2 (S2); if not, keeping the basic function of the mouse M;

Step 2 (S1) of detecting whether or not the simulation touch trigger button M3 of the mouse M is pressed again (one more time); if not, going to Step 3 (S3); if yes, keeping the basic function of the mouse M;

Step 3 (S3) of detecting whether or not the touch button is pressed; if yes, going to Step 4 (S4); if not, returning to Step 2 (S2); and

Step 4 (S4) of simulating the finger touching screen and performing touch functions, and determining whether or not all the previously pressed touch buttons are released; if yes, simulating to release the action of all the corresponding finger and returning to Step 2 (S2); if not, returning to Step 3 (S3) and continuously detecting whether or not the touch button is pressed by the finger. Above-mentioned not all the previously pressed touch buttons are released means that at least the previously pressed touch buttons not being released or parts of buttons being released or a new touch button being pressed.

When Step 3 (S3) in the embodiment is implemented, the touch button is a mouse button except the simulation touch trigger button M3; namely, when Step 3 (S3) enters and the mouse M works in the touch mode, the touch signal converter unit 20 separately intercepts the signals of the single or multiple buttons of the mouse M, namely the left and right buttons being pressed at the same time and converts them into touch points, thereby making the computer operating system execute the single-finger or multi-finger touch functions.

In the technical means of the embodiment, the simulation touch trigger button M3 is pressed one time to enter the touch mode and is then pressed one more time to recover the basic function of the mouse M.

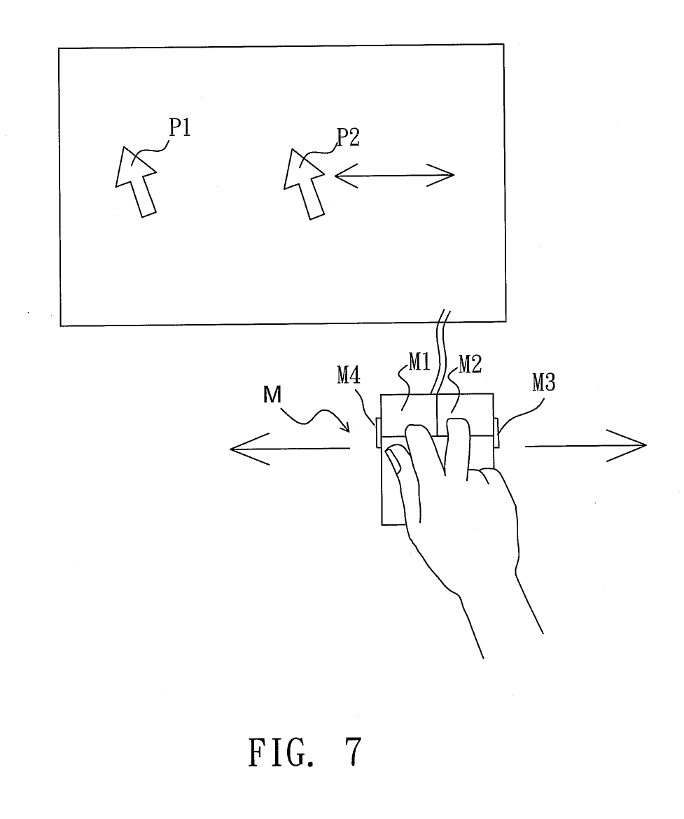

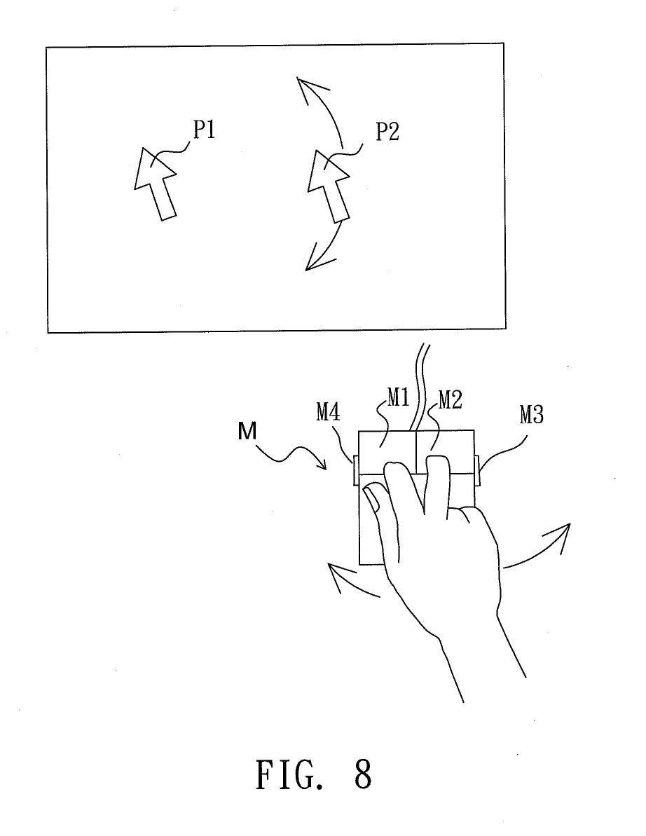

The technical means of the embodiment further includes a fixed-point button M4. With reference to FIGS. 7 and 8, to make the method achieve, when Step 3 (S3) enters and the mouse M works in the touch mode, the fixed-point button M4 is pressed to enter the fixed-point touch mode. In more detail, with the touch signal converter unit 20, when the fixed-point button M4 is pressed, it is simulated that a position where the mouse M is corresponding to the screen is pressed by the finger and the finger pressing signal is converted to a fixed position P1. The fixed-point position P1 cannot move with the mouse cursor. Then, the position of the mouse corresponding to the screen, when another button is pressed, is converted to a movable position P2. The computer operating system, based on the two positions (P1/P2) closed to each other or distant from each other, may bring a zoom-in or zoom-out effect, or based on the movement position P2 relative to the angular displacement variation of the fixed position P1, may control the rotation angle of the screen.

In the embodiment, in the fixed-point touch mode, the fixed-point position P1 and the moveable position P2 are not limited to the trigger time; namely, it is possible that, after the moveable position P2 is triggered, the fixed-point button M4 is pressed to trigger the fixed-point position P1.

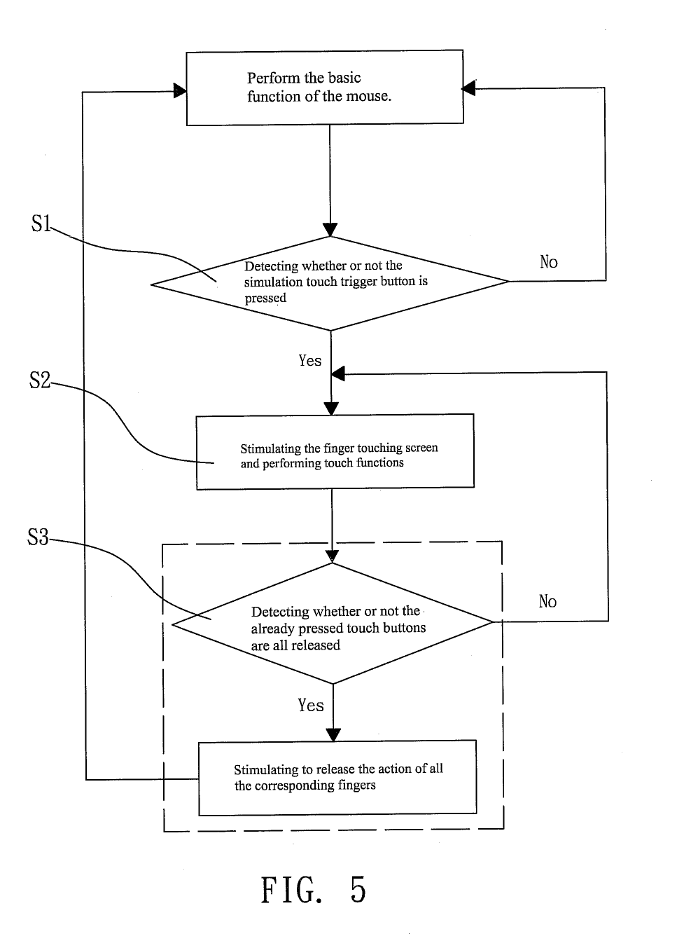

Refer to FIG. 5 as a flow chart of the method of simulating the touch screen operation by means of the mouse in a third embodiment of this invention. At the same time, refer to FIG. 4 as a 3D schematic view illustrating the mouse simulating the touch screen operation in a fixed-point touch mode according to this invention. The method comprises:

Step 1 (S1) of detecting whether or not the simulation touch trigger button M3 is pressed; if yes, going to Step 2 (S2); if not, keeping the basic function of the mouse M;

Step 2 (S2) of simulating the finger touching screen and performing touch functions; and

Step 3 (S3) of simulating the finger touching screen and performing touch functions, and determining whether or not all the previously pressed touch buttons are released; if yes, simulating to release the action of all the corresponding finger and keeping the mouse's basic function; if not, returning to Step 2 (S2) and continuously simulating that the screen is touched and pressed by the finger. Above-mentioned not all the previously pressed touch buttons are released means that at least the previously pressed touch buttons not being released or parts of buttons being released or a new touch button being pressed.

When Step 2 (S2) in the embodiment is implemented, the touch button can be the simulation touch trigger button M3 and a mouse button except the simulation touch trigger button M3.

In the technical means of the embodiment, the simulation touch trigger button M3 is pressed to enter the touch mode, and the simulation touch trigger button M3 is continuously pressed to continue working in the touch mode. When the touch buttons that were previously pressed are all released the basic function of the mouse M recovers.

In the embodiment, when Step 2 (S2) enters and the mouse M works in the touch mode, the touch signal converter unit 20 separately intercepts the signals of the single or multiple buttons of the mouse M, namely the left and right buttons being pressed at the same time, and converts them into touch points, thereby making the computer operating system execute the single-finger or multi-finger touch functions.

The technical means of the embodiment further includes a fixed-point button M4 being provided in the mouse. At the same time, refer to FIGS. 7 and 8. There are two manners making the method achieve.

In one manner, when Step 2 (S2) enters and the mouse M works in the touch mode, the fixed-point button M4 is pressed and then the position where the cursor of the mouse M stays is converted to the fixed-point position P1. In more detail, with the touch signal converter unit 20, when the fixed-point button M4 is pressed, it is simulated that a position where the mouse M is corresponding to the screen is pressed by the finger and the finger pressing signal is converted to a fixed position P1. The fixed-point position P1 cannot move with the mouse cursor. Then, when another button is pressed, the position where the mouse cursor stays is converted to the movable position P2. The computer operating system, based on the two positions (P1/P2) closed to each other or distant from each other, may bring a zoom-in or zoom-out effect, or based on the moveable position P2 relative to the angular displacement variation of the fixed position P1, may control the rotation angle of the screen.

In the other manner, when the basic function of the mouse M is kept and the fixed-point button M4 is pressed, Step 2 (S2) of working in the touch mode enters and the position where the cursor of the mouse M stays is converted to the fixed-point position P1 and the fixed-point touch mode is executed.

In the embodiment, the simulation touch trigger button M3 that is pressed can be a physical hardware button or can be triggered and activated by software.

In the embodiment, in the fixed-point touch mode, the fixed-point position P1 and the moveable position P2 are not limited to the trigger time; namely, it is possible that, after the moveable position P2 is triggered, the fixed-point button M4 is pressed to trigger the fixed-point position P1.

As shown in the figures, the mouse according to this invention works in a computer operating system supporting single-finger and multi-finger touch functions. The mouse M comprises at least one LED, one optical engine, one lens component, and one control element (not shown). The elements are used to detect the displacement of mouse M and control the cursor movement in the computer operating system (not described in detail here because of the mouse's basic functions). The mouse M further comprises a left button M1 and a right button M2. Especially, in this invention, the mouse M further comprises a simulation touch trigger button M3 and a touch signal converter unit 20, as shown in FIG. 2. In more detail, the mouse according to this invention works in the steps described in the first embodiment; namely, when the simulation touch trigger button M3 is pressed, the touch signal converter unit 20 intercepts the signals of a single or multiple buttons of the mouse and converts them into touch signals to input to the computer operating system, thereby simulating single-finger or multi-finger touch gestures.

Again with reference to FIG. 4, the mouse according to this invention further comprises a fixed-point button M4, which is implemented in the steps described in the second and third embodiments. In more detail, when the fixed-point button is pressed, namely the position where the cursor of the mouse M stays being converted to the fixed-point position P1, the fixed-point position P1 cannot move with the mouse cursor. Then, when another button is pressed, the position where the mouse cursor stays is converted to the movable position P2.

The single-finger or multi-finger touch function mentioned above depends whether or not the touch signal converter unit 20 intercepts a single or multiple mouse button signal at the same time.

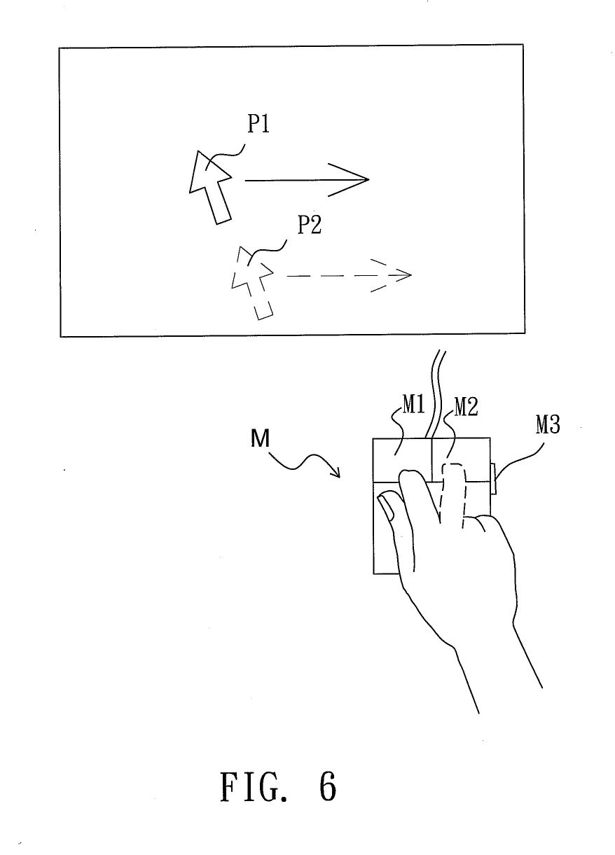

Refer to FIG. 6 illustrating the single-finger touch function. After the mouse works in the touch mode, when the button of the mouse M, such as left button M1, is continuously pressed, the computer operating system executes the single-finger touch function; namely, when the touch signal converter unit 20 intercepts only the working signal of single button of the mouse M, the touch signal converter unit 20 converts the single button signal into the touch point and simulates executing the single-finger touch function; that is, after the touch mode is executed, continuously pressing the button simulates pressing the screen by the finger. When the button is continuously pressed and the mouse cursor is moved, correspondingly the finger moves on the screen; when the continuously pressed button is released, correspondingly the finger does not press the screen.

Refer to FIG. 6 illustrating the multi-finger touch function. After the mouse works in the touch mode, when the multiple buttons of the mouse M are continuously pressed at the same time, the computer operating system may execute the multi-finger touch function, such as two fingers right, two fingers left, two fingers up, and two fingers down as the touch gestures; namely, when the touch signal converter unit 20 converts the signals multiple mouse button, such as left button M1 and right button M2 of the mouse, at the same time, it is indicated that the user operates the mouse M on the screen and press it at the same time. Further, the touch signal converter unit 20 converts the multi-button signals at the same time into the touch points and simulates executing the multi-finger touch function; for example, when the user operates in the touch mode and presses the left button M1 and right button M2 of the mouse at the same time and then moves the mouse to the right; that is, the touch signal converter unit 20 converts the signal of the left button M1 of mouse to a first touch point P1, and the signal of the right button M2 to a second touch point P2, and then the first touch point P1 and the second touch point P2 move to the right at the same time. What is mentioned also means that after the mouse works in the touch mode, another pressed button is continuously pressed, correspondingly another finger touching the screen; then the mouse cursor is moved, correspondingly all of the fingers moving on the screen.

Refer to FIG. 7 illustrating that the screen zoom-in, zoom-out or rotation according to this invention is implemented. After the mouse works in the touch mode, when the fixed-point button M4 of the mouse M is pressed, the position where the mouse cursor stays when the fixed-point button M4 is pressed is converted by the touch signal converter unit 20 to the first fixed position P1. The first position P1 cannot move with the mouse cursor. Then, the mouse is moved again to select a point on the screen, the button is continuously pressed, and the mouse is made to slide, making the touch signal converter unit 20 convert the selected point to a position and further define it to a second position P2 movable, thereby making the computer operating system depend on the first position P1 as the center. Regarding the distance between the two touch points P1 and P2, when the second position P2 stays close to the first position P1, the screen shrinks; alternatively, when the second position P2 moves and keeps away from P1, the screen is enlarged.

Refer to FIG. 8. Alternatively, the first position P1 is regarded as the center of circle, and the screen is controlled by the second position P2 relative to the angular displacement variation of the first position P1 (clockwise rotation or counter-clockwise rotation, making the screen, depending on the first touch point as the center of circle, rotate at an angle, namely rotating at the same angle with the first position P1.

Besides, in this invention, a multi-finger touch button M6 can be provided on the mouse M, (not shown in figures). The multi-finger touch button M6 can be configured by the user by means of the software. There are at least 2 fingers. In the touch mode, when the multi-finger touch button M6 is pressed, the position where the mouse cursor stays when the multi-finger touch button M6 is pressed is converted by the touch signal converter unit 20 to a position where the multi-finger press is given; namely, in a range of position where the cursor stays, a multi-finger touch on the position of the screen is simulated, and the mouse cursor is moved, equivalent to multi-finger movement on the screen. When the multi-finger touch button M6 is pressed one time again, the multi-finger touch exits and the multi-finger touch buttons M6 that are not pressed recover.

In this invention, the left and right buttons (M1, M2), simulation touch trigger button M3, fixed-point button M4, touch signal converter unit 20, multi-finger touch button M6 of the mouse . . . are electrically connected to a control component of the mouse M.

As described in this invention, the converted touch point or fixed position or movable position of the mouse that is correspondingly in the screen in the touch mode may work and be shown as a real image cursor or a non-real image cursor.

As described in this invention, the simulation touch trigger button M3 that is pressed can be a physical hardware button or can be triggered and activated featuring by software.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

What is claimed is:

1. A method of simulating the touch screen operation by means of a mouse, making the mouse work in a computer operating system supporting single-finger and multi-finger touch functions, the mouse comprising at least one simulation touch trigger button and one touch signal converter unit, the touch signal converter unit intercepting a button signal of the mouse, when the simulation touch trigger button is pressed, and converting the signal to a screen touch signal for executing the simulation of finger touch on the computer screen.

2. The method of simulating the touch screen operation by means of the mouse according to claim 1, wherein the method comprises:
Step 1 (S1) of detecting whether or not the simulation touch trigger button is pressed; if yes, going to Step 2 (S2); if not, keeping the mouse's basic function;
Step 2 (S2) of making the mouse work in the touch mode and activating the touch signal converter unit to separately intercept the button or operation signal of the mouse at the same time and to convert it into the touch function executed on the computer screen; and
Step 3 (S3) of detecting whether or not the previous working state of simulation touch trigger button is changed; if yes, returning to the mouse's basic function; if not, keeping the mouse's touch mode.

3. The method of simulating the touch screen operation by means of the mouse, making the mouse work in a computer operating system supporting single-finger and multi-finger touch functions, the mouse should comprise at least one touch signal converter unit, one simulation touch trigger button, one touch button, and one fixed-point button, the touch signal converter unit intercepting a button signal of the mouse, when the simulation touch trigger button is pressed, and converting the signal to a screen touch signal for executing the simulation of finger touch on the computer screen, and the simulation touch trigger button being pressed one more time to recover the basic function of the mouse.

4. The method of simulating the touch screen operation by means of the mouse according to claim 3, wherein the method comprises:
Step 1 (S1) of detecting whether or not the simulation touch trigger button of the mouse is pressed one time; if yes, going to Step 2 (S2); if not, keeping the mouse's basic function;
Step 2 (S2) of detecting whether or not the simulation touch trigger button of the mouse is pressed one more time; if not, going to Step 3 (S3); if yes, keeping the mouse's basic function;
Step 3 (S3) of entering the touch mode and detecting whether or not the touch button of the mouse entering the touch mode is pressed; if yes, going to Step 4 (S4); if not, returning to Step 2 (S2); and
Step 4 (S4) of simulating the finger touching screen and performing touch functions, and determining whether or not all the previously pressed touch buttons are released; if yes, simulating to release the action of all the corresponding fingers and returning to Step 2 (S2); if not, returning to Step 3 (S3) and continuously detecting whether or not the touch button is pressed by the finger.

5. The method of simulating the touch screen operation by means of the mouse according to claim 4, wherein the touch button is a mouse button except the simulation touch trigger button in Step 3 (S3).

6. The method of simulating the touch panel operation by means of the mouth according to claim 4 wherein when Step 3 (S3) entering the touch mode, the touch signal converter unit separately intercepts the signals of the single or multiple buttons of the mouse and converts them into touch points, thereby making the computer operating system execute the single-finger or multi-finger touch functions.

7. The method of simulating the touch screen operation by means of the mouse according to claim 4, wherein when Step 3 (S3) entering the touch mode, the fixed-point button is pressed to enter the fixed-point touch mode.

8. The method of simulating the touch screen operation by means of the mouse according to claim 7, wherein in the fixed-point touch mode, a position where the mouse is corresponding to the screen is converted to a fixed-point position, the fixed-point position does not move with the mouse cursor, the position of the mouse corresponding to the screen when another button is pressed, is converted to a movable position.

9. The method of simulating the touch screen operation by means of the mouse according to claim 8, wherein in the fixed-point touch mode, the fixed-point position and the moveable position are not limited to the trigger time; namely, it is also that, after the moveable position is triggered, the fixed-point button is pressed to trigger the fixed-point position.

10. The method of simulating the touch panel operation by means of the mouth according to claim 8, wherein the computer operating system, based on the two positions (the fixed-point position and the movable position) closed to each other or distant from each other, brings a zoom-in or zoom-out effect or based on the movement position relative to the angular displacement variation of the fixed position, controls the rotation angle of the screen.

11. The method of simulating the touch screen operation by means of the mouse, making the mouse work in a computer operating system supporting single-finger and multi-finger touch functions, the mouse comprising at least one simulation touch trigger button, one touch signal converter unit, one touch button, and one fixed-point button, the touch signal converter unit intercepting a button signal of the mouse when the simulation touch trigger button is pressed, and converting the signal to a screen touch signal for executing the simulation of finger touch on the computer screen, in which when the simulation touch trigger button is pressed, the mouse enters the touch mode, and the simulation touch trigger button is continuously pressed to make the mouse continue working in the touch mode, and when the simulation touch trigger button that was previously pressed is released, the mouse's basic function recovers.

12. The method of simulating the touch screen operation by means of the according to claim 11, wherein the method comprises:
Step 1 (S1) of detecting whether or not the simulation touch trigger button is pressed; if yes, going to Step 2 (S2); if not, keeping the mouse's basic function;
Step 2 (S2) of making the mouse work in the touch mode and simulating the finger touching screen and performing touch functions o; and
Step 3 (S3) of simulating the finger touching screen and performing touch functions, and determining whether or not all the previously pressed touch buttons are released; if yes, simulating to release the action of all the corresponding fingers and keeping the mouse's basic function; if not, returning to Step 2 (S2) and continuously simulating that the screen is touched and pressed by the finger.

13. The method of simulating the touch screen operation by means of the mouse according to claim 12, wherein the touch button in Step 2 (S2) is the simulation touch trigger button and a mouse button except the simulation touch trigger button.

14. The method of simulating the touch screen operation by means of the mouse according to claim 12, wherein when the fixed-point button is pressed, and the fixed-point touch mode enters.

15. The method of simulating the touch screen operation by means of the mouse according to claim 14, wherein in the fixed-point touch mode, a position where the mouse is corresponding to the screen is converted to a fixed-point position, the fixed-point position does not move with the mouse cursor, the position of the mouse corresponding to the screen when another button is pressed, is converted to a movable position.

16. The method of simulating the touch screen operation by means of the mouse according to claim 14, wherein in the fixed-point touch mode, the fixed-point position and the movable position are not limited to the trigger time; namely, it is also that, after the movable position is triggered, the fixed-point button is pressed to trigger the fixed-point position.

17. The method of simulating the touch screen operation by means of the mouse according to claim 15, wherein the computer operating system, based on the two position closed to each other or distant from each other, brings a zoom-in or zoom-out effect or based on the movement position relative to the angular displacement variation of the fixed position, controls the rotation angle of the screen.
